(19) United States
(12) Patent Application Publication
(10) Pub. No.: US 2007/0077401 A1
(43) Pub. Date: Apr. 5, 2007

(54) Absorber of electromagnetic radiation

(76) Inventor: Jonathan Pinto, Northampton (GB)

Correspondence Address: KENYON & KENYON LLP, ONE BROADWAY, NEW YORK, NY, 10004, US

(21) Appl. No.: 11/527,349

(22) Filed: Sep. 25, 2006

(30) Foreign Application Priority Data
Sep. 20, 2005 (GB) 0519267.9

(51) Int. Cl. B32B 18/00

(52) U.S. Cl. 428/195.1; 428/210

(57) ABSTRACT

An absorber of electromagnetic radiation, in particular for use with microwave or millimeter wavelength radiation, comprising a conducting ground plane (205) a meta-material surface element (200) positioned substantially parallel to and at a predetermined distance from the ground plane (205) by means of an intermediate dielectric layer (210), and a resistive element substantially coincident with the meta-material surface element (200), wherein the meta-material surface element (200) comprises a plurality of at least partially conducting inclusions in the shape of square loops (300) deposited in a periodic pattern over the surface of a dielectric material and wherein the predetermined distance is selected to ensure that, in use, the meta-material surface element (200) acts as a high impedance surface to incident electromagnetic radiation. Preferably, a covering dielectric layer (215) is provided over the meta-material surface element (200).

This invention relates to materials and structures designed to absorb electromagnetic radiation over a range of microwave or millimetric wave frequencies. Preferred embodiments of the present invention comprise passive structures arranged, in particular, but not exclusively, for use with electromagnetic radiation in the frequency range 2 to 18 GHz. However, it is generally understood that millimetric wave radiation includes radiation of up to 300 GHz in frequency.

There are a number of known materials and structures that have been designed to absorb, and in particular to limit reflection of electromagnetic radiation. A simple well known example is a so-called Salisbury screen which comprises a thin resistive film placed above a conducting metallic ground plane approximating a zero impedance perfect electrical conductor (PEC), separated by a layer of dielectric material. The Salisbury screen prevents reflection of incident radiation most strongly over a narrow range of frequencies according to the distance between the thin resistive film and the ground plane—one quarter of the wavelength of the most strongly attenuated radiation. Such narrow-band absorbers have relatively few applications in practice, limited also by their relative bulk, being approximately 4 cm thick when optimised for use at 2 GHz for example.

A much thinner structure is also known, comprising a so-called “meta-material” surface positioned parallel and close to a conducting ground plane, and a thin resistive sheet placed over the meta-material surface. The meta-material surface comprises a periodic pattern of thin conducting metallic inclusions deposited onto the surface of a dielectric material. The distance between the meta-material surface and the ground plane is significantly less than one quarter of the wavelength of the electromagnetic radiation to be most strongly attenuated. In this arrangement the meta-material surface, which can be regarded as a frequency-selective surface (FSS), has been arranged to act in conjunction with the ground plane as a high impedance surface, or artificial magnetic conductor (AMC), over a certain narrow frequency band. The resistive sheet provides the necessary loss in the reflected electromagnetic field.

Numerous patterns and shapes have been devised for the inclusions making up the meta-material surface and various techniques have been developed to optimise the geometry of those inclusions for a desired operational frequency band. However, the range of frequencies over which electromagnetic radiation is strongly attenuated using known designs of meta-material surface and associated absorber structure remains relatively narrow.

From a first aspect, the present invention resides in

an absorber of electromagnetic radiation, comprising:

a conducting ground plane;

a first meta-material surface element positioned substantially parallel to and at a predetermined distance from the ground plane by means of a first intermediate layer of dielectric material; and

a first resistive element substantially coincident with the first meta-material surface element,

wherein the first meta-material surface element comprises a plurality of at least partially conducting inclusions in the shape of square loops disposed in a periodic arrangement over a surface of dielectric material and wherein the predetermined distance is selected to ensure that, in use, the first meta-material surface element acts as a high-impedance surface to incident electromagnetic radiation over a predetermined range of frequencies.

In the present patent specification, the term “inclusion” is regarded as a term of the art and is generally understood to mean any geometric feature, regular or irregular in shape, that may be formed on or within the surface of a material.

In the present patent specification, the term “meta-material” is intended to relate to a material having a pattern of metallic or non-metallic inclusions deposited on or embedded in its surface.

Preferably, the square loops are made from resistive ink deposited by screen-printing onto the surface of a thin sheet of low admittance aramid tissue such as Nomex™, available in the UK from Goodfellow Cambridge Ltd. In this way, the resistive element may be combined with the meta-material surface element to give a structure of reduced complexity in comparison with one having a separate resistive element and meta-material surface element with metallic loops. Such a combined element affords better control of the overall properties of the structure during manufacture.

The inventors in the present case have found that the design of an absorber incorporating a meta-material surface element made up of square loops may be optimised to provide strong absorption of incident electromagnetic radiation over a significantly wider band of frequencies in the preferred range of 2-18 GHz than is possible with absorbers incorporating known meta-material surface patterns using other shapes, besides being easier to manufacture.

Preferably the absorber further comprises a covering layer of a dielectric material provided to cover the outermost meta-material surface and resistive element.

In further preferred embodiments of the present invention, one or more further meta-material surface elements may be provided, each one having a potentially different design of square loops, and each such element being separated from the first or further meta-material surface elements by means of further layers of dielectric material, not necessarily of the same dielectric material.

Preferred embodiments of the present invention may be manufactured using a range of dielectric materials according to the intended applications of the absorbers. The preferred materials are typically medium to low-loss dielectric materials with a low dielectric constant, particularly that used for the covering layer. For example, dielectric materials may comprise low-loss foams and low dielectric constant composite materials according to whether lightweight or more structural variants of the absorber are required. Different materials may be used for each dielectric layer in the absorber.

Preferred embodiments of the present invention may be applied to a range of military land, sea or air vehicles, in particular for the purpose of radar signature reduction. To this extent, the present invention extends to any such vehicles having electromagnetic absorbers according to preferred embodiments of the present invention applied to at least a part of their surfaces.

Preferred embodiments of the present invention will now be described, by way of example only, with reference to the accompanying drawings of which:

FIG. 1 provides a sectional representation of a prior art absorber of electromagnetic radiation;

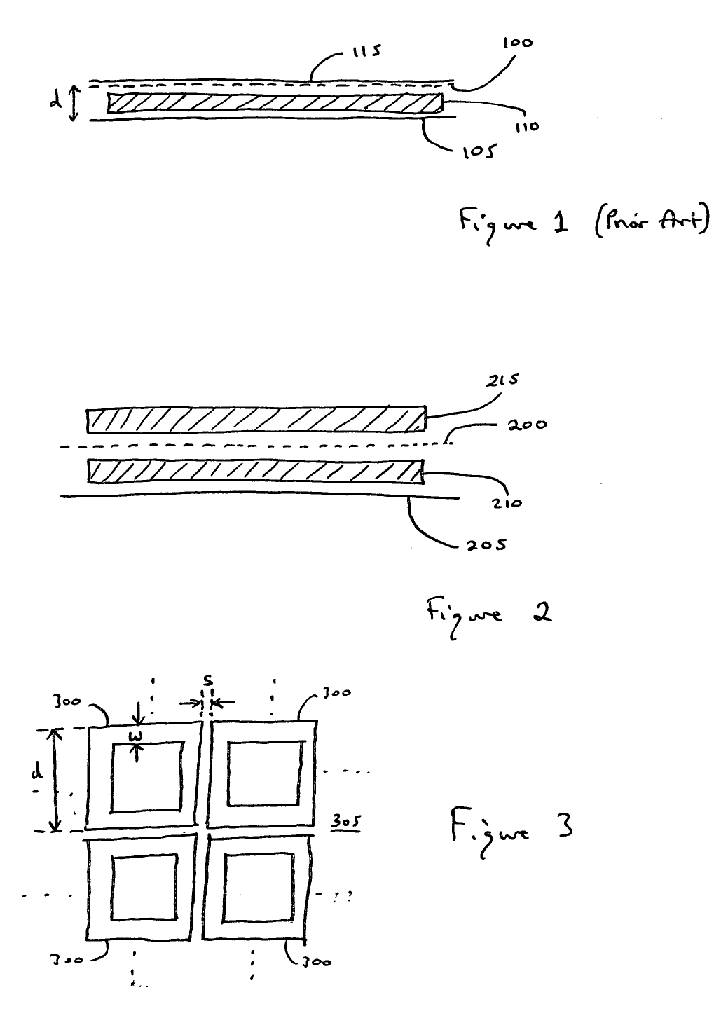

FIG. 2 provides a sectional representation of an absorber of electromagnetic radiation according to a first embodiment of the present invention;

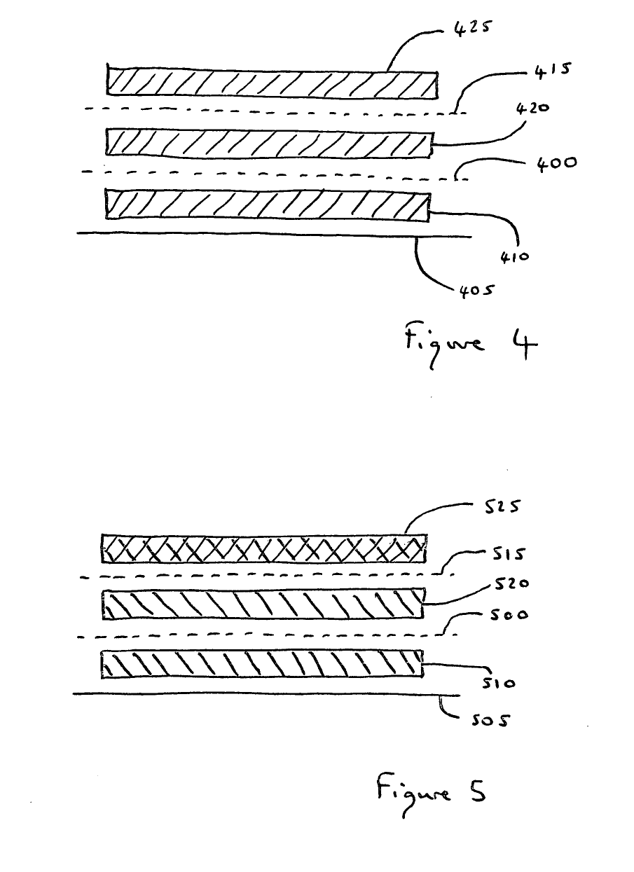

FIG. 3 provides a representation of a portion of a meta-material surface element according to preferred embodiments of the present invention;

FIG. 4 provides a sectional representation of an absorber of electromagnetic radiation having two meta-material surface elements according to a second embodiment of the present invention;

FIG. 5 provides a sectional representation of an absorber of electromagnetic radiation according to a third embodiment of the present invention.

When a transverse electromagnetic wave propagating in free space encounters a highly conductive planar surface approximating a zero impedance perfect electrical conductor (PEC), the incident wave is reflected and undergoes a 180° phase change. This results in a reflection coefficient of −1. Many conventional electromagnetic absorbers use this property of reflection from low impedance surfaces to achieve attenuation of an incident electromagnetic wave through cancellation. For example, the Salisbury screen mentioned above, consisting of a sheet of resistive material with a bulk resistance of 377Ω/square, separated from a low impedance surface by a low permittivity spacer with a thickness of some odd integer multiple of a quarter of the wavelength of radiation to be attenuated, achieves its absorption performance in this way.

A much thinner alternative to the Salisbury screen is known, as represented in section in FIG. 1. Any gaps shown in this representation, and in any of the other figures to be described below, are there only to enable the different elements of the respective structures to be more clearly distinguished. In practice, adjacent elements are bonded or otherwise held together without leaving any significant gaps.

Referring to FIG. 1, a known radiation-absorbing structure is seen to comprise a meta-material surface element 100 placed parallel to and at a distance significantly less than one quarter of the wavelength of radiation to be absorbed from a conducting ground plane 105. A layer 110 of dielectric material acts as a spacer between the element 100 and the ground plane 105. The meta-material surface element 100 is made up of many thin, small, flat inclusions distributed in a periodic manner over a flat surface. A surface of this type is known to be capable of acting as a high impedance surface or artificial magnetic conductor (AMC) to incident electromagnetic radiation if spaced an appropriate distance d from the conducting ground plane 105. If the meta-material surface element 100 itself is considered to be a shunt impedance Zₛₕᵤₙₜ to incident electromagnetic radiation, then by transmission line theory, the surface impedance Z_{surface} at the top of the structure represented in FIG. 1 is obtained by

$${Z}_{surface} = \frac{i {Z}_{shunt} η tan ( {k}_{nd} d )}{{Z}_{shunt} + i η tan ( {k}_{nd} d )}$$

where η is the transverse intrinsic impedance of the dielectric layer 110 and k_{nd} is the normal component of wave vector in the dielectric layer 110. From this equation it can be seen that in order to maximise the surface impedance of the element 100, and so generate an AMC, the value of Zₛₕᵤₙₜ should be made to approximate the relationship
Zₛₕᵤₙₜ≈−iη tan(k_{nd}d)
through an appropriate choice of dielectric material, distance d, and other parameters relating to the size and shape of inclusions making up the meta-material surface element 100.

If the apparent surface impedance Z_{surface} can be made extremely high with appropriate choices for these parameters, then the reflection co-efficient for an incident wave will become R =+1, rather than the more usual R=−1for near-perfect electrical conductors of zero impedance when a 180° phase change is suffered by incident waves on reflection. By placing a layer of resistive material 115 over the meta-material surface element 100, or making it substantially coincident with that element 100, where the electric field strength is very high, a significant proportion of reflected radiation can be absorbed.

For the purposes of the present invention, bulk dielectric materials are characterised by microwave properties such as their complex relative permittivity, the real part εᵣ relating to the extent to which the dielectric is polarised by the electric field of incident electromagnetic radiation and the imaginary part relating to the losses. However, the extent to which thin sheets of dielectric material impede or admit electromagnetic radiation is assessed by reference to the complex impedance (Z) or admittance (Y) of the material rather than its complex permittivity, due to larger uncertainties in the latter. Preferably, Z and Y are quoted relative to the characteristic impedance of free space to microwave radiation, 377 Ohms, and then normalised.

These parameter choices, and the designs for the resulting structures, are the subject of preferred embodiments of the present invention, in particular to the extent that they maximise the operational bandwidth of the resultant electromagnetic absorbers.

Absorbers according to preferred embodiments of the present invention have been designed on the assumption that high bandwidth may be achieved through generation of one or more high impedance surfaces or artificial magnetic conductors (AMC), within the structure. In a first preferred embodiment of the present invention, an absorber comprising a single meta-material surface element has been designed to provide high reflection losses to incident radiation over a wide range of frequencies in the 2-18 GHz band. The structure of this absorber will now be described with reference to FIG. 2.

Referring to FIG. 2, a representation of the preferred absorber is shown, in section, to comprise a meta-material surface element 200 separated from a conducting ground plane 205 by a means of a layer 210 of dielectric material. A further layer 215 of dielectric material is provided to cover the meta-material surface element 200. The dielectric material chosen for the layers 210, 215 preferably comprises a low-loss polyurethane foam such as Rohacell™ R71, available from Rohm GmbH. The real part of the complex relative permittivity and the loss tangent for Rohacell R71 have been derived from cavity resonator measurements to be εᵣ=1.119 and tanδ=3937e-6 respectively. Not shown in FIG. 2 are adhesive layers for bonding the different elements 200-215 together. Preferably Scotchweld™ 2216 adhesive is used, available in the UK from 3M plc. Corresponding parameters for this adhesive are εᵣ=3.354 and tanδ=18.42e-3. Rohacell™ foam was selected on the basis that it is relatively inexpensive to buy, is simple to work with, and the low real part of the relative permittivity of the material has been found to be of help in maximising the absorption bandwidth of the structure.

The meta-material surface element 200 comprises a periodic arrangement of shapes of resistive ink deposited, for example using a screen printing technique, onto the surface of a thin sheet of Nomex™, the sheet being approximately 60 μm in thickness. The normalised lumped admittance for the Nomex™ material was measured using a quasi-optical free space focussed beam system. The real part of the admittance was found to be extremely small as is assumed to be zero for the purposes of optimisation. The imaginary part of the admittance was measured as 0.006 S/sq. Preferably, for the resistive ink, the real part of the admittance is an optimisation parameter, but the imaginary part of the admittance is considered to be non-dispersive and to remain constant (at 0.45 S/sq) as the real part varies. Forming the shapes with resistive ink serves to combine with the meta-material surface element 200 what would otherwise have been a separate resistive element in the structure. However, it is not essential that a resistive element and a meta-material surface element are combined. A separate meta-material surface element would in that case comprise a pattern of conducting metallic shapes formed on the surface of a suitable dielectric material.

Numerous experiments were conducted to determine the shape likely to provide the greatest bandwidth of absorption by the structure. A method of moments-based solver was used to predict the reflection loss from an absorber constructed using a range of different periodic patterns for the meta-material surface element 200. A square loop shape was eventually discovered to have the potential to give ultra-wideband performance in the 2-18 GHz band in particular. A meta-material surface element 200 will now be described with reference to FIG. 3 according to preferred embodiments of the present invention, and in particular when used to make an absorber according to the first embodiment of the present invention described above.

Referring to FIG. 3, a portion of a meta-material surface element 200 is shown comprising a periodic pattern of square loop shapes 300 that has been found by the inventors in the present case, with appropriate choice of dimensions, to provide high operational bandwidths when used in absorbers according to preferred embodiments of the present invention. The square loops 300 are identical, equally spaced, and comprise resistive ink of an appropriately selected resistivity deposited on a thin (60 μm) sheet of Nomex™ substrate 305. The length I and track width w of each square loop, their spacing s and the resistivity of the ink used to create the loops are amongst the parameters considered in an optimisation process with the aim of maximising the bandwidth of reflection loss, preferably at the −15 dB level (representing a 97% attenuation of reflected radiation).

An optimised structure according to the first embodiment of the present invention has been found to provide a reflection loss of at least −15 dB over a frequency range of 10.7 GHz within the 2-18 GHz band, corresponding to a fractional bandwidth of 107.5%, where fractional bandwidth B is calculated according to the formula

$$B = 2 [ \frac{{f}_{u} - {f}_{l}}{{f}_{u} + {f}_{l}} ]$$

where fₗ and fᵤ are the lower and upper frequency bounds respectively at the specified level of reflection loss, in this example at the −15 dB level. An optimised structure of the type shown in FIG. 2, according to the first embodiment of the present invention, has the following properties:

thickness of dielectric layer 210=6.9 mm;

thickness of covering dielectric layer 215=7.4 mm;

loop length I=1 3.2 mm;

loop track width w=2.96 mm;

loop spacing s=0.54 mm;

admittance of resistive ink=4.86+0.45i S/sq (normalised)

At 107.5%, the performance of this structure greatly exceeds the 45% fractional bandwidth achievable by a single layer Salisbury screen, optimised for the −15 dB reflection loss level at normal incidence of radiation, with a front layer resistive sheet of bulk resistance 354Ω/sq.

The parameters, in particular the dimensions listed above and defining the design of an absorber according to the first embodiment of the present invention, are quoted to an accuracy of 10 microns where appropriate. It has been shown by the inventors in the present case that such accuracy is achievable in practice for the manufacture of an absorber using the materials specified. However, while the dimensions given represent an optimal design, each parameter may be varied to a certain extent while still providing an absorber with acceptable operational bandwidth, for example at a reduced level of attenuation of −10 dB. The extent to which any one parameter or combination of parameters may be varied while retaining an acceptable level of operational bandwidth will be discussed below and may be demonstrated through routine experimentation or predicted by computer modelling of the structure. However, in practice, it should not be necessary to vary any of the parameters significantly, other than of necessity as a result of normal manufacturing tolerances, unless a more optimal combination of parameters were to be found.

In a second embodiment of the present invention, a radiation-absorbent structure having two meta-material surface elements has been created and found to offer improved operational bandwidth in comparison with the structure shown in FIG. 2, as will now be described with reference to FIG. 4.

Referring to FIG. 4, a representation of the structure is shown, in section, to comprise a first meta-material surface element 400, placed parallel to and separated from a conducting ground plane 405 by a first layer 410 of dielectric material, a second meta-material surface element 415, placed parallel to and separated from the first meta-material surface element 400 by a second layer 420 of dielectric material, and a third, covering layer 425 of dielectric material placed over the second meta-material surface element 415. As with the first embodiment described above with reference to FIG. 2, adhesive layers for bonding the different layers 400-425 of the structure together are not shown in FIG. 4.

In common with the first embodiment described above, each of the layers 410, 420, 425 of dielectric material comprise Rohacell™ R71 polyurethane foam, and the adhesive layers for bonding the different elements together comprise Scotchweld™ 2216 adhesive. The thickness of the adhesive layers lies between 100 μm and 180 μm, but they are preferably 140 μm thick. Each of the first and second meta-material surface elements 400, 415 comprise a periodic distribution of square loop deposits of resistive ink, as described above with reference to FIG. 3, but with differently selected dimensions to those used in the first embodiment of the present invention. In particular, an optimised structure according to the second embodiment of the present invention has the following properties:

thickness of first dielectric layer 410=6.18 mm;

thickness of second dielectric layer 420=7.20 mm;

thickness of third, covering, dielectric layer 425=4.14 mm;

loop length I for first meta-material surface element=15.16 mm;

loop track width w for first meta-material surface element=3.71 mm;

loop spacing s for first meta-material surface element=0.31 mm;

loop length I for second meta-material surface element=13.77 mm;

loop track width w for second meta-material surface element=1.24 mm

loop spacing s for second meta-material surface element=1.71 mm; admittance of resistive ink=4.19+0.45i S/sq (normalised).

This structure provides an operational bandwidth of 12.82 GHz at the −20 dB level, within the 2-18 GHz band, corresponding to fractional bandwidth of 128% Optimisation at the −15 dB level yields a fractional bandwidth of 144%.

A third embodiment of the present invention will now be described with reference to FIG. 5. The electromagnetic absorber in this third embodiment comprises two meta-material surface elements, as in the second embodiment described above, but makes use of composite e-glass/LTM26 and Dyneena/LTM26 materials for the dielectric layers rather than the lightweight and more flexible foam material used for the dielectric layers of the first and second embodiments. The Dyneena/LTM26 material comprises a woven polyethene cloth in a resin (the LTM26 is the resin); “e-glass” is an engineering e-grade glass cloth. These materials are available in the UK from Advanced Composites Group of Heanor, Derbyshire. Both materials are standard aerospace products.

Use of such composite materials allows for a significantly thinner structure—approximately 9 mm—than would be possible in the equivalent structure using foam dielectric layers—a thickness of approximately 18 mm—and provides for more structural applications of the absorber than would be possible with those of the lightweight embodiments, although with a slightly reduced operational frequency bandwidth. Furthermore, adhesive layers can be dispensed with.

Referring to FIG. 5, a sectional representation of the structure in this third embodiment is shown to comprise a first meta-material surface element 500, placed parallel to and separated from a conducting ground plane 505 by a first dielectric layer 510 comprising an e-glass/LTM26 composite material, a second meta-material surface element 515 placed parallel to and separated from the first meta-material surface element 500 by a second dielectric layer 520 comprising an e-glass/LTM26 composite material, and a third, covering dielectric layer 525 comprising a Dyneena/LTM26 composite material. An optimised structure according to this third embodiment of the present invention has the following properties:

thickness of first dielectric layer 510=2.51 mm;

thickness of second dielectric layer 520=3.17 mm;

thickness of third, covering, dielectric layer 525=4.23 mm;

loop length I for first meta-material surface element=6.12 mm;

loop track width w for first meta-material surface element=1.61 mm;

loop spacing s for first meta-material surface element=0.1 3 mm;

loop length I for second meta-material surface element=5.69 mm;

loop track width w for second meta-material surface element=0.38 mm loop spacing s for second meta-material surface element=0.56 mm;

admittance of resistive ink=7.8+0.45i S/sq (normalised).

This structure provides an operational fractional bandwidth of 126% at the −15 dB level within the 2-18 GHz band.

Whereas, in the structure according to the second embodiment described above the various layers were held together by adhesive layers, in this Dyneena/LTM26 and e-glass/LTM26 composite-based structure, adhesive layers are not required.

It is thought that the choice of Dyneena/LTM26 material for the third, covering dielectric layer 525 serves to impedance-match the absorber panel to freespace, so reducing front-face reflections of incident radiation. The Dyneena/LTM26 and e-glass/LTM26 materials have substantially differing permittivities and this difference is believed to further contribute to the wide-band performance of the absorber when incorporated into the design.

An absorber panel according to this third embodiment of the present invention is manufactured by first cutting the materials to size and laying the layers of material on an appropriately sited “caul” plate, with the pattern of inclusions of resistance ink included in the correct positions. The layered assembly is then placed in a vacuum bag and compressed to one atmosphere during a conventional oven cure at 60° C. for a period of approximately 16 hours.

While preferred embodiments of the present invention described above relate to absorber panels that would typically be manufactured as substantially flat panels, it will be appreciated that in many applications these panels would need eventually to be applied to curved surfaces. Where the absorber panels are flexible, as in the first and second embodiments of the present invention, they may be manufactured as flat panels and deformed subsequently by predetermined amounts to the required shape. Absorbers according to the third embodiment are intended to be less flexible, if not rigid, and would in practice be manufactured as panels of the required curvature or as shapes such as cylinders, cones, or any other desired three-dimensional shape.

In order to ensure that the size and spacing of the inclusions on the meta-material surface elements 200, 400, 415, 500, 515 in particular match the desired design values when an absorber panel is moulded to its final curvature, these dimensions can be adjusted when manufacturing each initially flat panel so that when the panel is bent or moulded from its initial flat form to its final curvature, the resultant dimensions match the design values, e.g. following stretching or compression of the materials at respective levels in the absorber structure. Furthermore, if the shape of the inclusions on the meta-material surface element are likely to change shape as a result of deforming the initially flat panel, then the shape of the inclusions may also be adjusted for manufacture to ensure that following deformation of the manufactured panel, the resultant shape of the inclusions matches the required design.

While, in describing preferred embodiments of the present invention above, optimal dimensions have been quoted accurate to 10 μm in some cases, variations of ±10% in the values of any one or more of the dimensions for the first and second embodiments have been found to result in electromagnetic radiation absorbers giving acceptable levels of performance, i.e. similar bandwidth but at a lower level of attenuation of −10 dB, or slightly reduced (by 10-15%) bandwidth but with attenuation maintained at the higher level of −15 dB. Variations in the thickness of adhesive layers should preferably be kept within the range of ±5% of the optimal values of 140 μm for these embodiments. In the third embodiment, making use of e-glass/LTM26 composite materials for the first and second dielectric layers 510, 520, and Dyneena /LTM26 composite material for the covering layer 525, variations of ±5% in the thickness of the e-glass/LTM26 layers 510, 520, ±15% in the resistive ink admittance, and ±10% in other parameter values have been found to result in absorbers giving an acceptable level of performance.

It is preferred that in those embodiments having two meta-material surface elements the square loops in the two elements are aligned as closely as possible, but at least to the extent that the sides of the loops of one element are substantially parallel to those of the other element. However, it has been shown that the absorbers according to preferred embodiments of the present invention are tolerant of slight offsets, of the order of one or two millimetres of lateral offset, or up to 10° of rotational offset between the two elements, from an optimal alignment.

1. An absorber of electromagnetic radiation, comprising:
a conducting ground plane;
a first meta-material surface element positioned substantially parallel to and at a predetermined distance from the ground plane by means of a first intermediate layer of dielectric material; and
a first resistive element substantially coincident with the first meta-material surface element,
wherein the first meta-material surface element comprises a plurality of at least partially conducting inclusions in the shape of square loops disposed in a periodic arrangement over a surface of dielectric material and wherein the predetermined distance is selected to ensure that, in use, the first meta-material surface element acts as a high-impedance surface to incident electromagnetic radiation over a predetermined range of frequencies.

2. An absorber according to claim 1, wherein the square loops are formed from resistive ink deposited onto the surface of dielectric material, so that the first resistive element is combined with the first meta-material surface element.

3. An absorber according to claim 2, wherein the surface of dielectric material is provided by a separate film layer of dielectric material.

4. An absorber according to claim 1, 2 or 3, further comprising a covering layer of dielectric material provided to cover the first meta-material surface element and the substantially coincident first resistive element.

5. An absorber according to claim 1, 2 or 3, further comprising a second meta-material surface element comprising a plurality of at least partially conducting inclusions in the shape of square loops disposed in a periodic arrangement over a further surface of dielectric material, positioned substantially parallel to and at a predetermined distance from the first meta-material surface by means of a second intermediate layer of dielectric material, and a second resistive element substantially coincident with the second meta-material surface.

6. An absorber according to claim 5, wherein the square loops of the second meta-material surface element comprise resistive ink deposited onto the further surface of dielectric material, so that the second resistive element is combined with the second meta-material surface element.

7. An absorber according to claim 6, wherein the further surface of dielectric material is provided by a further separate film layer of dielectric material.

8. An absorber according to claim 5, 6 or 7, further comprising a covering layer of dielectric material provided to cover the second meta-material surface and the substantially coincident second resistive element.

9. An absorber according to any one of the preceding claims, wherein the ground plane and the other elements of the absorber are bonded together by means of adhesive layers.

10. An absorber according to claim 2, wherein the surface of dielectric material is provided by a surface of the first intermediate layer of dielectric material.

11. An absorber according to claim 6, wherein the further surface of dielectric material is provided by a surface of the second intermediate layer of dielectric material.

12. An absorber according to claim 10 or claim 11, wherein the surface or further surface of dielectric material is provided by a surface of the covering layer of dielectric material.

13. An absorber according to any one of the preceding claims, wherein the layers of dielectric material are flexible, enabling the absorber to be deformed.

14. An absorber according to claim 13, wherein the absorber is manufactured in the form of one or more flexible flat panels.

15. An absorber according to claim 13 or claim 14, wherein the extent of deformation of each panel of the absorber is predetermined and wherein the shape and dimensions relating to the arrangement of inclusions on each said meta-material surface element is adjusted for manufacture of the respective panel so that, in use, following deformation of the panel to the predetermined extent, said shape and dimensions match a set of predetermined design criteria for the absorber.

16. An absorber according to any one of claims 1 to 12, wherein the layers of dielectric material are substantially rigid.

17. An absorber according to claim 16, wherein the absorber is manufactured in the form of one or more sections of predefined shape.

18. An absorber according to claim 4, wherein the first intermediate layer and the covering layer of dielectric material comprise a polyurethane foam material.

19. An absorber according to claim 8, wherein the first and second intermediate layers and the covering layer of dielectric material comprise a polyurethane foam material.

20. An absorber according to claim 8, wherein the first and second intermediate layers and the covering layer of dielectric material comprise a composite material.

21. An absorber according to claim 20 or claim 21, wherein the first intermediate layer of dielectric material comprises a different material to that of the second intermediate layer and/or to that of the covering layer of dielectric material.

22. An absorber according to claim 18, wherein:
(i) the thickness of the first intermediate layer of dielectric material lies in the range 6.21 mm to 7.59 mm;
(ii) the thickness of the covering layer of dielectric material lies in the range 6.66 mm to 8.14 mm;
(iii) the first meta-material surface comprises square loops of resistive ink wherein the loop length lies in the range 11.88 mm to 14.52 mm, the loop track width lies in the range 2.66 mm to 3.26 mm and the loop spacing lies in the range 0.49 mm to 0.59 mm;
(iv) the lumped admittance of the resistive ink lies in the range 4.13+0.45i S/square to 5.59+0.45i S/square.

23. An absorber according to claim 19, wherein:
(i) the thickness of the first intermediate layer of dielectric material lies in the range 5.56 mm to 6.80 mm;
(ii) the thickness of the second intermediate layer of dielectric material lies in the range 6.48 mm to 7.92 mm;
(iii) the thickness of the covering layer of dielectric material lies in the range 3.73 mm to 4.55 mm;
(iv) the first meta-material surface comprises square loops of resistive ink wherein the loop length lies in the range 13.64 mm to 16.68 mm, the loop track width lies in the range 3.34 mm to 4.08 mm and the loop spacing lies in the range 0.28 mm to 0.34 mm;
(v) the second meta-material surface comprises square loops of resistive ink wherein the loop length lies in the range 12.39 mm to 15.15 mm, the loop track width lies in the range 1.12 mm to 1.36 mm and the loop spacing lies in the range 1.54 mm to 1.88 mm; and
(vi) the lumped admittance of the resistive ink lies in the range 3.56+0.45i S/square to 4.61+0.45i S/square.

24. An absorber according to claim 20, wherein:
(i) the first intermediate layer of dielectric material comprises an e-glass and resin composite material having a thickness in the range 2.38 mm to 2.64 mm;
(ii) the second intermediate layer of dielectric material comprises an e-glass and resin composite material having a thickness in the range 3.01 mm to 3.33 mm;
(iii) the covering layer of dielectric material comprises a polyethene and resin composite material having a thickness in the range 3.81 mm to 4.65 mm;
(iv) the first meta-material surface comprises square loops of resistive ink wherein the loop length lies in the range 5.51 mm to 6.73 mm, the loop track width lies in the range 1.45 mm to 1.77 mm and the loop spacing lies in the range 0.12 mm to 0.14 mm;
(v) the second meta-material surface comprises square loops of resistive ink wherein the loop length lies in the range 5.12 mm to 6.26 mm, the loop track width lies in the range 0.34 mm to 0.42 mm and the loop spacing lies in the range 0.50 mm to 0.62 mm; and
(vi) the lumped admittance of the resistive ink lies in the range 6.63+0.45i S/square to 8.97+0.45i S/square.

25. An absorber of electromagnetic radiation substantially as hereinbefore described with reference to the accompanying drawings.
